(19) United States
(12) Patent Application Publication
(10) Pub. No.: US 2016/0322842 A1
(43) Pub. Date: Nov. 3, 2016

(54) CHARGING DEVICE FOR A BATTERY PACK FOR A HAND-HELD POWER TOOL

(71) Applicant: Robert Bosch GmbH, Stuttgart (DE)

(72) Inventors: Constanze Sorhage, Leinfelden-Echterdingen (DE); Thilo Koeder, Leinfelden-Echterdingen (DE); Alexander Osswald, Stuttgart (DE); Marc-Alexandre Seibert, Stuttgart (DE)

(21) Appl. No.: 15/135,165

(22) Filed: Apr. 21, 2016

(30) Foreign Application Priority Data
Apr. 28, 2015 (DE) 102015207730.6

(51) Int. Cl. H02J 7/00

(52) U.S. Cl. CPC H02J 7/0044; H02J 7/0045; H02J 7/007; H02J 2007/0096

(57) ABSTRACT

A charging device for electrical charging of a battery pack of a hand-held power tool including a charging interface for establishing an electrical and/or mechanical coupling of the charging device to an interface unit of the battery pack, the charging interface having at least two counter-contact elements for electrical and/or mechanical contacting of corresponding contact elements of the battery pack. The counter-contact elements include a third counter-contact element designed to forward information transmitted by the third contact element with respect to a first set of predefined battery system parameters of the battery pack to the charging control unit, and a fourth counter-contact element designed to forward information transmitted by the fourth contact element with respect to an instantaneous operating parameter of the battery pack to the charging control unit.

### CROSS REFERENCE

The present application claims the benefit under 35 U.S.C. §119 of German Patent Application No. DE 102015207730.6 filed on Apr. 28, 2015, which is expressly incorporated here by reference in its entirety.

### FIELD

The present invention relates to a charging device for a battery pack for a hand-held power tool, a tool system, and a method for optimized charging of a battery pack.

### BACKGROUND INFORMATION

Electric hand-held power tools, for example, impact screw drivers, drills, angle grinders, jigsaws, circular saws, or planers for the needs of craftsmen or handymen usually have either an AC motor or a DC motor as the drive motor. While the former is generally supplied with alternating current from the grid via a power cable, the electrical power for supplying the DC motor generally comes from a so-called battery pack, a rechargeable battery in a housing which may be coupled to the housing of the hand-held power tool, which is electrically connected to the current supply lines of the DC motor during the coupling of the two housings.

Conventional battery packs of this type generally and have rechargeable batteries, generally a plurality of battery cells connected in parallel and/or in series. A battery pack is thus understood as a battery packet, which is preferably made up of multiple electrically interconnected battery cells and may store electrical energy, deliver the energy necessary for operating the hand-held power tool, and is accommodated interchangeably in a chamber, an interface, or the like of a hand-held power tool. The electrical contacting is mostly carried out in the area of the locking device.

Conventional devices for battery packs generally have charging electronics situated in a housing and include a receptacle for a battery pack to be charged and an interface which is situated in the area of the receptacle and has counter-contact elements for the contact elements of the battery pack. Electrical recharging of a battery pack is possible using these types of charging devices.

Basically, different battery cells, which are designated according to the materials used, may be used. These include in particular, lithium-ion, lithium polymer, nickel-metal hydride, or lithium iron phosphate cells. Common to all is that the battery cells with the same service time have slightly different battery system parameters, for example, due to manufacturing tolerances, temperature or mechanical influences.

The factors which influence changes in the cell characteristics and thus the aging of the cells are, among other things, the storage voltage, the operating voltage, the charge and discharge rates, the charge state, the defined end-of-charge and end-of-discharge voltage thresholds, the calendrical age of the cell, the number of previous charge and discharge cycles, the speed of the charge/discharge alternation, and the temperature during all idle and operating states, i.e., during storage, when idle, during charging and during discharging. A distinction is basically made between variable operating parameters, for example, the temperature, and the predefined battery system parameters, for example, the defined end-of-charge and end-of-discharge voltage levels.

Present battery pack systems are controlled by management systems which monitor the cells and regulate the charging or discharging current. The goal of conventional methods of this type is always to extend the service life of the battery pack while taking the battery system parameters into account.

### SUMMARY

It is an object of the present invention to refine the conventional methods and to provide a charging device, and to optimize the charging process of a battery pack over the related art, in particular to accelerate it and to simultaneously maximize the service life of the battery pack. Another object of the present invention is to provide a tool system which includes a charging device and a battery pack and a hand-held power tool which are adapted to one another in a way that an optimization of the charging process may be achieved.

This object may be achieved by a charging device, a tool system, and a method for optimized charging of a battery pack in accordance with the present invention.

In accordance with the present invention, it is provided that a charging device for electrical charging of a battery pack of a hand-held power tool includes a charging interface for electrical and/or mechanical coupling of the charging device to an interface unit of the battery pack, the charging interface having at least two counter-contact elements for electrical and/or mechanical contacting of corresponding contact elements of the battery pack, and a charging control unit, the charging control unit being electrically connected to the counter-contact elements and designed to read in and further process information about the counter-contact elements. In accordance with the present invention, the counter-contact elements include a third counter-contact element, which is designed to contact a corresponding third contact element of the battery pack, the third counter-contact element being a signal contact element and designed for the purpose of forwarding information transmitted by the third contact element with respect to a first set of predefined battery system parameters of the battery pack to the charging control unit; and that the counter-contact elements include a fourth counter-contact element for contacting a fourth contact element of the battery pack, the fourth counter-contact element being a signal contact element and designed for the purpose of forwarding information transmitted by the fourth contact element with respect to an instantaneous operating parameter of the battery pack to the charging control unit.

This ensures that the charging control unit considers the first set of predefined battery system parameters of the battery pack during the charging process of the battery pack, whereby the charging process may be more efficiently matched to the battery pack to be charged. Furthermore, the charging process may be carried out faster and more smoothly, whereby an extension of the service life of the battery pack may in turn be achieved.

In one particularly preferred specific embodiment, the charging interface includes a fifth counter-contact element for contacting a fifth contact element of the battery pack, the fifth counter-contact element being a signal contact element and is designed for the purpose of forwarding information transmitted by the fifth contact element with respect to a second set of predefined battery system parameters of the battery pack to the charging control unit.

Advantageously, the charging interface has a first counter-contact element for contacting a first contact element, which is an electrically positive pole of the battery pack, and a second counter-contact element for contacting a second contact element, which is an electrically negative pole of the battery pack.

Particularly advantageously, the first set of predefined battery system parameters includes at least one of the parameters: end-of-discharge voltage of the battery pack and performance class of the battery pack. The second set of predefined battery system parameters includes at least one of the parameters: end-of-charge voltage of the battery pack, number of cells of the battery pack, or a cell chemical used in the battery pack. Basically, exactly one piece of information from a parameter is provided via a counter-contact element. In the case of performance class, this should be primarily understood as the different DC voltages of the battery pack, for example 3.6 volts, 7.2 volts, 10.8 volts, 14.4 volts, 18 volts, or 36 volts.

In another specific embodiment, the instantaneous operating parameter of the battery pack is the instantaneous temperature of the battery pack.

Furthermore, the object may be achieved by a tool system for charging a battery pack of a hand-held power tool, the tool system including a charging device according to the present invention, a battery pack, and a hand-held power tool. The battery pack has an interface unit for electrical and/or mechanical coupling of the battery pack to the charging device.

The interface unit includes contact elements for electrical and/or mechanical contacting of corresponding counter-contact elements of the charging device; the contact elements having a third contact element via which information is transmitted to a charging control unit of the charging device; and the contact elements having a fourth contact element via which information with respect to an instantaneous operating parameter of the battery pack is transmitted to the charging control unit of the charging device.

Advantageously, the information transmitted via the third contact element relates to a first set of predefined battery system parameters, particularly at least one of the parameters: end-of-discharge voltage of the battery pack, and performance class of the battery pack. In another advantageous embodiment, the information transmitted via the fourth contact element relates to a second set of predefined battery system parameters, in particular at least one of the parameters: end-of-charge voltage of the battery pack, number of cells of the battery pack, or a cell chemical used in the battery pack. The charging control unit is preferably designed for the purpose of regulating the charging process of the battery pack at least partially as a function of the transmitted information of the first set and/or second set of predefined battery system parameters of the battery pack.

Furthermore, the object is achieved by a method for optimized charging of a battery pack of a hand-held power tool using a charging device. According to the present invention, it is provided that the battery pack is electrically connected to the charging device via an interface unit on the battery pack side and a charging interface on the charge device side; that information from at least one first set of predefined battery pack system parameters of the battery pack: in particular an end-of-discharge voltage of the battery pack, performance class of the battery pack and/or information from at least one second set of predefined battery system parameters of the battery pack, at least an end-of-charge voltage of the battery pack, number of cells of the battery pack, or a cell chemical used in the battery pack, are read in by a charging control unit of the charging device; and that the charging process of the battery pack is controlled by the charging control unit of the charging device, the charging process being regulated at least partially as a function of the first set and/or the second set of predefined battery system parameters of the battery pack. Advantageously, the step of controlling the charging process includes that the charge time is regulated at least partially as a function of the first set and/or of the second set of battery system parameters of the battery pack.

In general, a hand-held power tool within the scope of the present application is understood to mean all hand-held power tools including a tool head, which is able to be set in rotation or translation and which is directly drivable via a gearing or a planetary gear, by a drive motor, for example, cordless screwdrivers, rechargeable drills, percussion drills, multifunction tools, saws, shears, grinders, and/or cordless combination drills. Transmission of electrical power is to be understood in this context in particular to mean that the hand-held power tool is supplied with power via the battery pack.

Additional features, application options and advantages of the present invention arise from the subsequent description of the exemplary embodiments of the present invention which are represented in the figures. One should take into consideration that the features shown are only of descriptive nature and may also be used in combination with features of other further developments described above and are not intended to restrict the present invention in any way.

### BRIEF DESCRIPTION OF THE DRAWINGS

The present invention is explained below in greater detail based on preferred exemplary embodiments, the same reference numerals being used for the same features. The figures are schematic.

FIG. 1 shows a view by way of example of a hand-held power tool including a battery pack according to the present invention.

FIG. 2 shows a perspective view of a charging device according to the present invention.

FIG. 3 shows a perspective view of a battery pack.

FIG. 4 shows a top view of the battery pack from FIG. 3.

FIG. 5 shows a perspective bottom view of a hand-held power tool.

### DETAILED DESCRIPTION OF EXAMPLE EMBODIMENTS

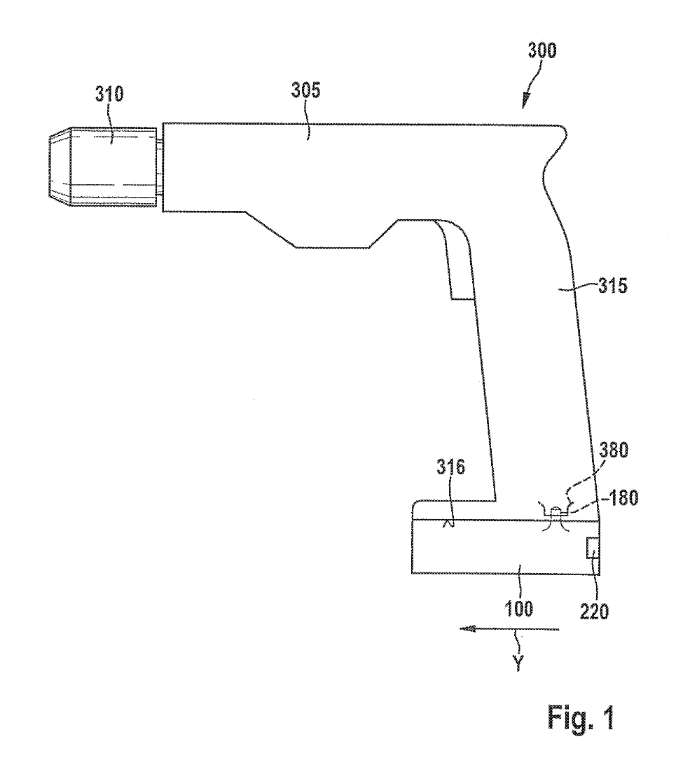

FIG. 1 shows an electrical device designed as a hand-held power tool 300. According to the specific embodiment shown, hand-held power tool 300 is mechanically and electrically connectable to the battery pack 100 for off-grid power supply. Hand-held-power tool 300 in FIG. 1 is designed for example as a cordless screw drill. However, reference is made to the fact that the present invention is not limited to cordless screw drills, but instead may be used in different hand-held power tools 300 which are operated by a battery pack 100. Hand-held power tool 300 has a base body 305, on which a tool holder 320 is fixed, and a handle 315 including an interface 380, on which a corresponding interface 180 of a battery pack 100 according to the present invention is situated, in this case in the locked position. Battery pack 100 is configured as a slide-in battery pack.

Upon mounting battery pack 100 on hand-held power tool 300, accommodating means provided on hand-held power tool 300, e.g., guide grooves and guide ribs, engage with corresponding guide elements 110 of battery pack 100, battery pack 100 being inserted in a sliding direction y along the accommodating means of handle 315, battery pack 100 being inserted along a lower outer surface 316 of handle 315 oriented essentially perpendicularly to the longitudinal direction of handle 315 into the battery pack accommodation of hand-held power tool 300. In the position shown in FIG. 1, battery pack 100 is fixed on handle 315 of hand-held power tool 300 and locked by locking means. The locking means include, among other things, a locking element and an actuating element 220. By actuating actuating element 220, battery pack 100 may be disengaged from handle 315 of hand-held power tool 300.

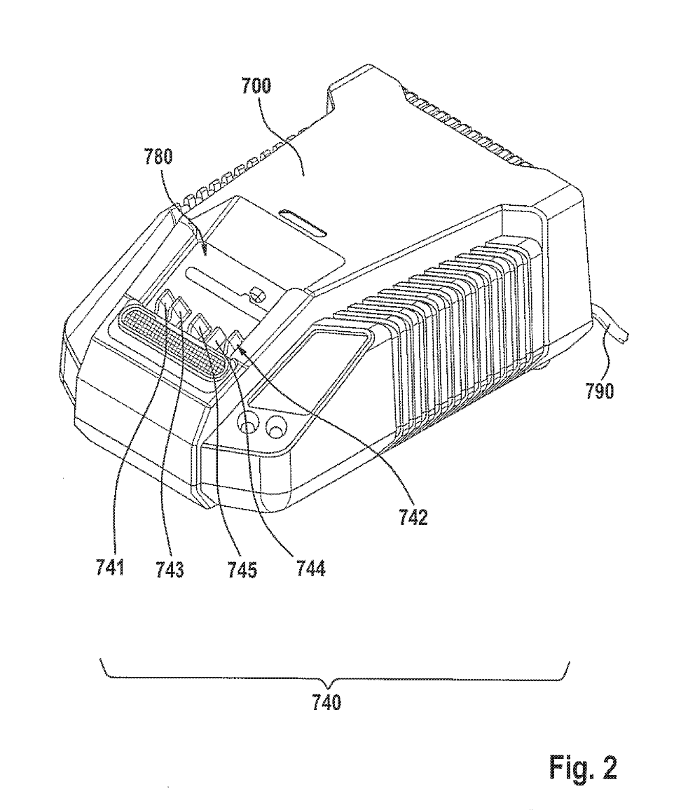

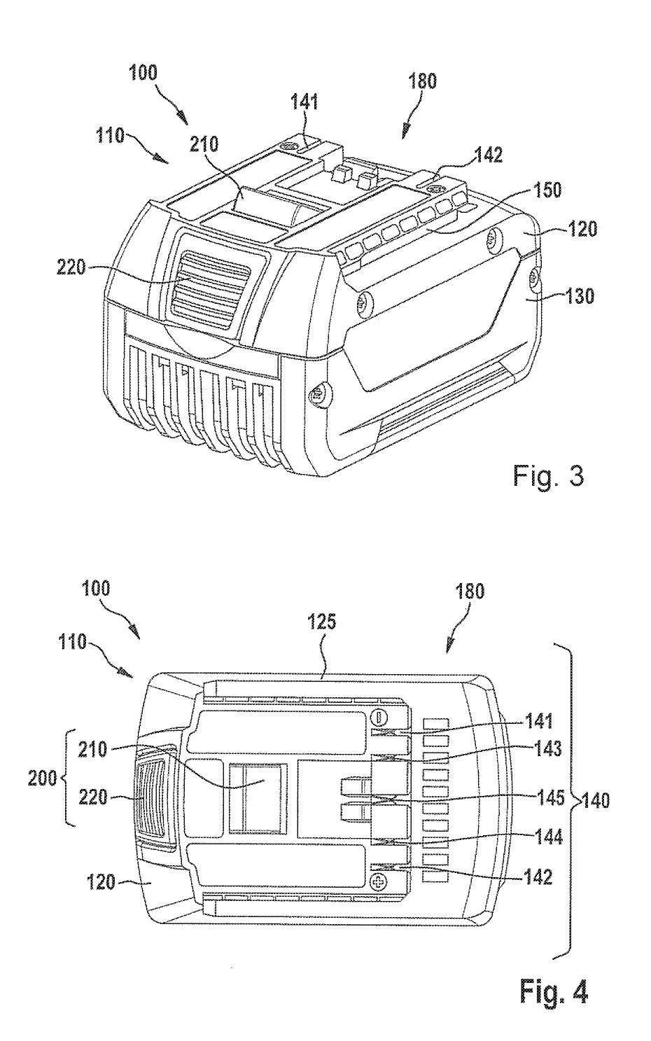

FIG. 2 shows a charging device 700 according to the present invention. Charging device 700 is connected to the mains network via a mains cable 790 and has a charging control unit, not shown, which is designed for the purpose of controlling the charging process of a battery pack 100 shown in detail in FIGS. 3 and 4. Charging device 700 has a charging interface 780 in order to establish, with a corresponding interface 180 of battery pack 100, a mechanical and electrical connection between charging device 700 and battery pack 100. In the specific embodiment shown, charging interface 780 has counter-contact elements 740 which cooperate with corresponding contact elements 140 of battery pack 100 in order to transmit charging current and also to exchange information between charging device 700 and battery pack 100. A specific function is thereby assigned to each of counter-contact elements 740; this function is fixed and is unchangeable. This specific function may, for example, be the transmission of a predefined piece of information in the form of a signal transmitted by a corresponding contact element of battery pack 100 or the contacting of a fixed electrical pole of battery pack 100 during the charging process.

Counter-contact elements 740 include in detail a first counter-contact element 741 and a second counter-contact element 742 at which the electrically positive and electrically negative poles are applied during the charging process, and a third counter-contact element 743, a fourth counter-contact element 744, and a fifth counter-contact element 745.

In the specific embodiment shown, third counter-contact element 743 is designed for the purpose of contacting a third contact element 143 of battery pack 100, via which information with respect to a second set of predefined battery system parameters of battery pack 100 may be transmitted to the charging control unit. In particular, the second set of battery system parameters according to a preferred specific embodiment of the present invention includes at least one of the parameters: end-of-charge voltage of battery pack 100, number of cells of battery pack 100, in particular number of cells connected in parallel or in series, and/or a cell chemical used in battery pack 100.

Fourth counter-contact element 744 is designed for the purpose of contacting a fourth contact element 144 of battery pack 100, via which information with respect to a first set of predefined battery system parameters of battery pack 100 may be transmitted to the charging control unit. The term “predefined battery system parameter” is to be understood as a parameter of battery pack 100, which is not subject to any type of change or fluctuation during operation of battery pack 100. In particular, the first set of battery system parameters according to a preferred specific embodiment of the present invention includes at least one of the parameters: end-of-discharge voltage and/or performance class of battery pack 100, the performance class may be the listed voltage of battery pack 100, also a current carrying capacity of battery pack 100, and an electrical capacity of battery pack 100.

Fifth counter-contact element 745 is designed for the purpose of contacting a fifth contact element 145 of battery pack 100, via which information with respect to a first instantaneous operating parameter of battery pack 100 is transmitted to the charging control unit. The term “instantaneous operating parameter” is to be understood as a parameter of battery pack 100 which is subject to changes or fluctuation during operation of battery pack 100. In particular, the first instantaneous operating parameter according to a preferred specific embodiment of the present invention is the instantaneous temperature of battery pack 100.

Because the first set of predefined battery system parameters is transmitted to the charging control unit, it is thus possible that the charging control unit may take these battery system parameters into account during the charging process of battery pack 100. In particular, the charging process may then be carried out faster and may be better matched to battery pack 100. Thus, an accelerated charging and/or extension of the service life of battery pack 100, among other things, may be achieved.

FIGS. 3 and 4 show different views of battery pack 100 which may be used in a tool system according to the present invention. This has a housing 110 made up of a first housing component 120 and a second housing component 130, the housing accommodating between first housing component 120 and second housing component 130 at least one, preferably, and shown here, a plurality of battery cells 400 interconnected in parallel or in series. Battery cells 400 are positioned between the two housing components 120, 130 preferably with either the aid of a cell bracket 600 or with the aid of cardboard tubes to insulate battery cells 400 from one another. Battery pack 100 is configured in the embodiment variant shown as a slide-in battery pack.

For disengageable mounting of battery pack 100 on hand-held power tool 300 or on charging device 700, battery pack 100 has an interface 180 for disengageable mechanical and electrical connection to a corresponding interface 380 of hand-held power tool 300 or a corresponding interface of charging device 700. Upon mounting battery pack 100, accommodating means, e.g., guide grooves and guide ribs, of hand-held power tool 300 or of charging device 700 engage with corresponding guide elements of battery pack 100, battery pack 100 being inserted in a contacting direction y along the accommodating means, and interface 180 of battery pack 100 being inserted into corresponding interface 380 of hand-held power tool 300 or corresponding interface 780 of charging device 700. Battery pack 100 may be assigned to hand-held power tool 300 and/or to charging device 700 via interfaces 180, 380.

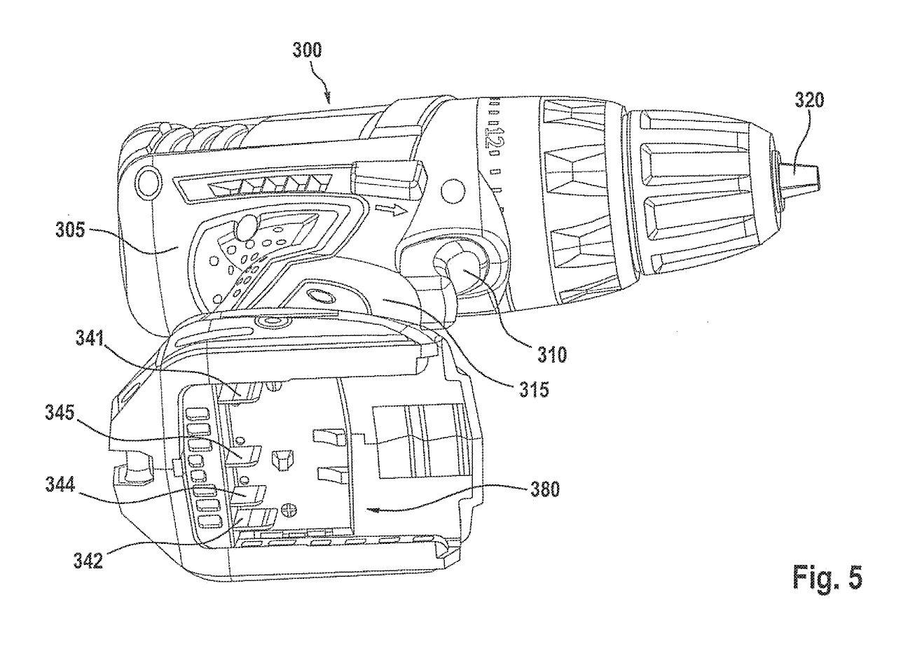

As is apparent in FIG. 3, interface 180 additionally includes contact elements 140. Contact elements 140 correspond to the greatest possible extent with counter-contact elements 740 of charging device 700 shown in FIG. 2 and with counter-contact elements 340 of hand-held power tool 300 shown in FIG. 5. In detail, the following contact elements 140 are:

The electrically positive and the electrically negative poles are in contact with a first contact element 141 and a second contact element 142 during the charging process. These two contact elements 141, 142 are designed as voltage contact elements and function as charging and/or discharging contact elements.

Furthermore, a third contact element 143, a fourth contact element 144, and a fifth contact element 145 are apparent, which are designed as signal contact elements and are used for the signal transmission from battery pack 100 to hand-held power tool 300 or to charging device 700 and/or from hand-held power tool 300 or charging device 700 to battery pack 100. In the specific embodiment shown, third contact element 143 is designed for the purpose of transmitting information with respect to the second set of predefined battery system parameters of battery pack 100 to the charging control unit and/or to hand-held power tool 300. Fourth contact element 144 is designed for the purpose of transmitting information with respect to the first set of predefined battery system parameters of battery pack 100 to the charging control unit and/or to hand-held power tool 300. Fifth contact element 145 is designed for the purpose of transmitting information with respect to the first instantaneous operating parameter of battery pack 100 to the charging control unit and/or to hand-held power tool 300.

To lock battery pack 100 on handle 315, battery pack 100 is inserted in sliding direction y along handle 315, namely along a lower outer surface of handle 315 oriented generally perpendicularly to the longitudinal direction of handle 315. In the position shown in FIG. 1, battery pack 100 is locked on handle 315 by locking means 200. Locking means 200 include, among other things, a locking element 210 indicated only schematically and actuating element 220. By actuating actuating element 220, battery pack 100 may be disengaged from handle 315 of hand-held power tool 300. After unlocking battery pack 100, it may be separated from handle 315, namely by pushing battery pack 100 along a lower surface of handle 315 counter to sliding direction y. Upon mounting battery pack 100 on hand-held power tool 300, locking element 210 engages with a corresponding accommodation, not shown in detail, in handle 315 of hand-held power tool 300.

FIG. 5 shows hand-held power tool 300 used in the tool system according to the present invention. Hand-held power tool 300 has an interface 380 with contacting elements 340. Interface 380 is designed for the purpose of establishing a mechanical and/or electrical connection between hand-held power tool 300 and battery pack 100 when battery pack 100 is coupled. Interface 380 has counter-contact elements 340 which correspond with contact elements 140 of battery pack 100.

During the operation of hand-held power tool 300, the electrically positive and the electrically negative poles are in contact with a first counter-contact element 341 and a second counter-contact element 342. Furthermore, a fourth counter-contact element 344, and a fifth counter-contact element 345 are apparent. In the specific embodiment shown, fourth counter-contact element 344 is designed for the purpose of transmitting information with respect to the first set of predefined battery system parameters of battery pack 100 to hand-held power tool 300. Fifth counter-contact element 345 is designed for the purpose of transmitting information with respect to the first instantaneous operating parameter of battery pack 100 to the control unit of hand-held power tool 300.

In addition to the specific embodiments described and illustrated, further specific embodiments are possible, which may include further modifications and combinations of features.

What is claimed is:

1. A charging device for electrical charging of a battery pack of a hand-held power tool, comprising:
a charging interface to establish at least one of an electrical and mechanical coupling of the charging device to an interface unit of the battery pack, the charging interface having at least two counter-contact elements for at least one of electrical and mechanical contacting, of corresponding contact elements of the battery pack; and
a charging control unit electrically connected to the counter-contact elements and designed to read in and further process information about the counter-contact elements;
wherein the counter-contact elements include a third counter-contact element designed to contact a corresponding third contact element of the battery pack, the third counter-contact element being a signal contact element and designed to forward information transmitted by the third contact element with respect to a first set of predefined battery system parameters of the battery pack to the charging control unit; and
wherein the counter-contact elements include a fourth counter-contact element for contacting a fourth contact element of the battery pack, the fourth counter-contact element being a signal contact element and designed to forward information transmitted by the fourth contact element with respect to an instantaneous operating parameter of the battery pack to the charging control unit.

2. The charging device as recited in claim 1, wherein the charging interface includes a fifth counter-contact element to contact a fifth contact element of the battery pack, the fifth counter-contact element being a signal contact element and designed to forward information transmitted by the fifth contact element with respect to a second set of predefined battery system parameters of the battery pack to the charging control unit.

3. The charging device as recited in claim 1, wherein the charging interface has a first counter-contact element to contact a first contact element, which is an electrically positive pole of the battery pack, and a second counter-contact element to contact a second contact element, which is an electrically negative pole of the battery pack.

4. The charging device as recited in claim 1, wherein the first set of predefined battery system parameters includes at least one of the following parameters: end-of-discharge voltage of the battery pack, and performance class of the battery pack.

5. The charging device as recited in claim 1, wherein the second set of predefined battery system parameters includes at least one of the following parameters: end-of-charge voltage of the battery pack, number of cells of the battery pack, and a cell chemical used in the battery pack.

6. The charging device as recited in claim 1, wherein the instantaneous operating parameter of the battery pack is at least one of: (i) an instantaneous temperature of the battery pack, and (ii) an instantaneous temperature of individual battery cells.

7. A tool system for charging a battery pack of a hand-held power tool, comprising:
a charging device including a charging interface to establish at least one of an electrical and mechanical coupling of the charging device to an interface unit of the battery pack, the charging interface having at least two counter-contact elements for at least one of electrical and mechanical contacting, of corresponding contact elements of the battery pack, the charging device further including a charging control unit electrically connected to the counter-contact elements and designed to read in and further process information about the counter-contact elements, wherein the counter-contact elements include a third counter-contact element designed to contact a corresponding third contact element of the battery pack, the third counter-contact element being a signal contact element and designed to forward information transmitted by the third contact element with respect to a first set of predefined battery system parameters of the battery pack to the charging control unit, and wherein the counter-contact elements include a fourth counter-contact element for contacting a fourth contact element of the battery pack, the fourth counter-contact element being a signal contact element and designed to forward information transmitted by the fourth contact element with respect to an instantaneous operating parameter of the battery pack to the charging control unit; and
the battery pack having an interface unit for at least one of electrical and mechanical coupling of the battery pack to the charging device, the interface unit including contact elements for at least one of electrical and mechanical contacting of corresponding counter-contact elements of the charging device, the contact elements having a third contact element via which information is transmitted to the charging control unit of the charging device, and the contact elements having a fourth contact element via which information with respect to an instantaneous operating parameter of the battery pack is transmitted to the charging control unit of the charging device.

8. The tool system as recited in claim 7, wherein the information transmitted via the third contact element relates to a first set of predefined battery system parameters including at least one of the following parameters: end-of-discharge voltage of the battery pack, and performance class of the battery pack.

9. The tool system as recited in claim 8, wherein the information transmitted via the fourth contact element relates to a second set of predefined battery system parameters including at least one of the following parameters: end-of-charge voltage of the battery pack, number of cells of the battery pack, and a cell chemical used in the battery pack.

10. The tool system as recited in claim 9, wherein the charging control unit is designed to regulate the charging process of the battery pack at least partially as a function of the transmitted information of at least one of the first set and the second set of predefined battery system parameters of the battery pack.

11. A method for optimized charging of a battery pack of a hand-held power tool including a charging device, the method comprising:
electrically connecting the battery pack to the charging device via an interface unit on a battery pack side and a charging interface on a charging device side;
at least one of: (i) reading in information of at least one first set of predefined battery system parameters of the battery pack including an end-of-discharge voltage of the battery pack, and performance class of the battery pack, and (ii) reading in information of at least one second set of predefined battery system parameters of the battery pack including at least one of: an end-of-charge voltage of the battery pack, number of cells of the battery pack, and a cell chemical used in the battery pack by a charging control unit of the charging device; and
controlling the charging process of the battery pack by the charging control unit of the charging device, the charging process being regulated at least partially as a function of at least one of the first set and the second set of predefined battery system parameters of the battery pack.

12. The method as recited in claim 11, wherein the step of controlling the charging process includes regulating a charge time at least partially as a function of the at least one of the first set and the second set of predefined battery system parameters of the battery pack.
